(19) United States
(12) Patent Application Publication
(10) Pub. No.: US 2026/0217276 A1
(43) Pub. Date: Jul. 30, 2026

(54) AUTONOMOUS PATH PLANNING IN DEFICIENT MAPPING CONDITIONS

(71) Applicant: ELTA SYSTEMS LTD., Ashdod (IL)

(72) Inventors: Gil FREIDLIN, Givat Shmuel (IL); Adi ZIGDON, Kfar Yona (IL); Uriya Gura MANTVER, Tel Aviv (IL)

(21) Appl. No.: 19/146,465

(22) PCT Filed: Dec. 20, 2023
(86) PCT No.: PCT/IL2023/051287

§ 371 Date: Jul. 8, 2025

(30) Foreign Application Priority Data
Dec. 28, 2022 (IL) 299576

(51) Int. Cl. B60W 60/00; G01C 21/00; G01C 21/34

(52) U.S. Cl. CPC B60W 60/0011; G01C 21/3446; G01C 21/3848

(57) ABSTRACT

The presently disclosed subject matter includes a computer implemented method and a computer system dedicated for autonomous path planning in an autonomous vehicle for traversing an area in offroad conditions. According to the suggested approach selective path planning logic is applied when selecting a desired path, where the map is divided into a plurality of subregions, each subregion being defined by one or more respective ranges from the vehicle and uncharted cells in the map are processed depending on the respective subregion in which they are located. Segments that include cells classified as non-traversable and segments that include uncharted cells located in the short-range subregion are excluded from candidate paths. A preferred path is selected from the candidate paths and used when steering the vehicle.

### TECHNICAL FIELD

The presently disclosed subject matter relates to autonomous vehicles, and more specifically to real-time path planning in autonomous vehicles.

### BACKGROUND

An autonomous vehicle (also known as an uncrewed vehicle) is essentially a mobile machine that integrates sensory data with computer-based decision-making for the purpose of autonomously driving the vehicle. The vehicle can, in some cases, carry passengers, e.g., operators that cannot see the surrounding environment and/or cannot manoeuvre the vehicle. Among its various tasks, an autonomous vehicle is many times required to navigate in unknown, ever-changing, and sometimes hazardous environments.

### GENERAL DESCRIPTION

According to a first aspect of the presently disclosed subject matter there is provided a computer implemented method of autonomous path planning in an autonomous vehicle for traversing an area in offroad conditions, the method comprising:
obtaining a map representing an area around the vehicle; wherein the map is generated by scanning an area around the vehicle, and comprises at least one scanned area and at least one unscanned area;
generating one or more candidate paths leading the vehicle from a current location towards a desired destination, wherein the generating comprises:
   dividing the map into a plurality of subregions, each subregion being defined by one or more respective ranges from the vehicle, including at least: short-range subregion, medium-range subregion, and long-range subregion; wherein the map is divided into cells, where cells in a scanned area are classified to a class selected from at least two classes, comprising traversable and non-traversable, and wherein cells in an unscanned area are defined as uncharted cells;
   applying a selective path planning logic on uncharted cells depending on the respective subregion in which they are located, wherein:
      in the short-range subregion, considering uncharted cells as non-traversable;
      in the long-range subregion, considering uncharted cells as traversable;
   excluding from the one or more candidate paths segments that include cells classified as non-traversable and segments that include uncharted cells located in the short-range subregion;
selecting a preferred path from the one or more candidate paths; and generating steering instructions for steering the vehicle in accordance with the path.

In addition to the above features, the method according to this aspect of the presently disclosed subject matter can optionally comprise one or more of features (i) to (xv) listed below, in any technically possible combination or permutation:
i. wherein applying the selective path planning logic further comprises:
   in the medium-range subregion, assigning a penalty to a segment that include uncharted cells that negatively affects a score of a respective candidate path that includes the segment.
ii. The method further comprising:
   dynamically updating one or more candidate paths as the vehicle is advancing along the preferred path, comprising:
   obtaining an updated map generated based on updated scanning output data, wherein the update map comprises one or more of an unscanned area that was previously in the medium-range subregion of the map and is in the short-range subregion, and an unscanned area that was previously in the long-range subregion and is in the medium-range subregion;
   excluding segments, from any one of the one or more candidate paths, that cross uncharted cells in the short-range subregion;
   and applying a penalty to segments, in any one of the one or more candidate paths, that cross uncharted cells in the medium-range subregion, where the penalty negatively affects a respective score of a candidate path;
   recalculating a respective score for each candidate path; and selecting a preferred path from the one or more candidate paths according to the respective scores; and generating steering instructions for steering the vehicle in accordance with the path.
iii. wherein, responsive to determining that the preferred path includes segments crossing the short-range subregion that include uncharted cells, the method comprising updating the preferred path to replace the segments with one or more other segments that circumvent the uncharted cells.
iv. The method further comprising:
   responsive to identifying uncharted cells in the medium-range subregion, generating a speed control command for slowing down the vehicle to thereby increase probability of successfully scanning unscanned areas in subsequent scans.
v. The method further comprising:
   operating a sensors-suit comprising one or more sensors onboard the vehicle for repeatedly scanning the area around the vehicle, to thereby generate respective scanning output data; and
   operating a computer for generating and updating the map based on the scanning output data.
vi. The method further comprising dynamically adapting the size of one or more (e.g., two or more) of the plurality of subregions according to one or more real-time operational conditions.
vii. wherein the one or more real-time operational conditions include vehicle speed, the method further comprising:
   responsive to increase in vehicle speed (above a threshold or proportional to speed), increasing the size of the short-range subregion and decreasing the size of the long-range subregion and/or medium-range subregion.
viii. The method further comprising:
   responsive to decrease in vehicle speed, decreasing the size of the short-range subregion and increasing the size of the long-range subregion and/or medium-range subregion.
ix. wherein the one or more real-time operational conditions include obstacle density, the method further comprising:
   determining obstacle density and response to determination that obstacle density is above a certain value, increasing the size of the short-range subregion and decreasing the size of the long range-subregion and/or medium-range subregion.
x. The method further comprising determining obstacle density and response to determination that obstacle density is below a certain value, decreasing the size of the short-range subregion and increasing the size of the long range-subregion and/or medium subregion.
xi. The method further comprising: executing the steering instruction and controlling one or more control devices for leading the vehicle along the preferred path.
xii. wherein the vehicle is an Unmanned Ground Vehicle.
xiii. wherein the map is generated relative to the vehicle by accumulating scanning output data in an advancement direction of the vehicle as the vehicle advances, and omitting from the map scanning output data representing areas in a direction opposite to the advancement direction.
xiv. wherein applying the selective path planning logic further comprises:
   in the medium-range subregion, assigning a penalty to a segment that includes uncharted cells that negatively affect a score of a respective candidate path that includes the segment.
xv. The method further comprising controlling the permissiveness of incorporation of uncharted cells in the one or more candidate paths by dynamically adapting the penalty assigned to segments in the medium-range subregion that includes uncharted cells. This enables toggle between higher vehicle safety and more restrictive path planning, and lower vehicle safety and more permissive path planning.

According to another aspect of the presently disclosed subject matter there is provided a non-transitory computer readable storage medium tangibly embodying a program of instructions that, when executed by a computer, causing the computer to perform a method as described above with respect to the first aspect.

According to another aspect of the presently disclosed subject matter there is provided a system mountable on an autonomous vehicle for autonomous path planning for traversing an area in offroad conditions, the system comprising at least one processing circuitry configured to execute the method as described above with respect to the first aspect.

A vehicle comprising a system as disclosed herein above.

The non-transitory computer readable storage media, and the system disclosed herein according to various aspects, can optionally further comprise one or more of features (i) to (xv) listed above, mutatis mutandis, in any technically possible combination or permutation.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 is a block diagram schematically illustrating an example of a system, according to some examples of the presently disclosed subject matter;

FIG. 2 is a high-level flowchart showing operations performed during autonomous path planning in the presence of uncharted areas, according to some examples of the presently disclosed subject matter;

FIG. 3 is a flowchart showing a more detailed view of operations in FIG. 2, according to some examples of the presently disclosed subject matter;

FIGS. 4a-4c are schematic illustrations demonstrating the division of the mapped area into range-zones, according to some examples of the presently disclosed subject matter;

FIG. 5 are schematic illustrations that demonstrate certain principles of the path planning process, according to some examples of the presently disclosed subject matter.

FIGS. 6-9 are schematic illustrations that demonstrate certain principles of the path planning process, according to some examples of the presently disclosed subject matter.

### DETAILED DESCRIPTION

In the drawings and descriptions set forth, identical reference numerals indicate those components that are common to different embodiments or configurations. Elements in the drawings are not necessarily drawn to scale.

Unless specifically stated otherwise, as apparent from the following discussions, it is appreciated that, throughout the specification, discussions utilizing terms such as “generating”, “obtaining”, “dividing”, “updating”, “identifying”, “selecting” or the like, include an action and/or processes of a computer that manipulate and/or transform data into other data, said data represented as physical quantities, e.g. such as electronic quantities, and/or said data representing the physical objects.

The terms “computer”, “computer device”, “computerized device” or the like, should be expansively construed to include any kind of hardware electronic device with a data processing circuitry (e.g., digital signal processor (DSP), a GPU, a TPU, a field programmable gate array (FPGA), an application specific integrated circuit (ASIC), microcontroller, microprocessor etc.), which can comprise, for example, one or more computer processors operatively connected to computer memory, loaded with executable instructions for executing operations as further described below. For example, navigation computer 116, mapping unit 117, classification unit 118 and path planning unit 119 can be implemented as one or more computer devices, each device including one or more processing circuitries configured to execute operations as described herein.

Operations in accordance with the teachings herein may be performed by a computer specially constructed for the desired purposes, or by a general-purpose computer specially configured for the desired purpose by a computer program stored in a computer readable storage medium.

As used herein, the phrase “for example”, “such as”, “for instance” and variants thereof, describe non-limiting embodiments of the presently disclosed subject matter. Reference in the specification to “one example”, “some examples”, “other examples”, or variants thereof, means that a particular feature, structure, or characteristic described in connection with the embodiment(s), is included in at least one embodiment of the presently disclosed subject matter. Thus, the appearance of the phrase “one example”, “some examples”, “other examples”, or variants thereof, does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately, or in any suitable sub-combination.

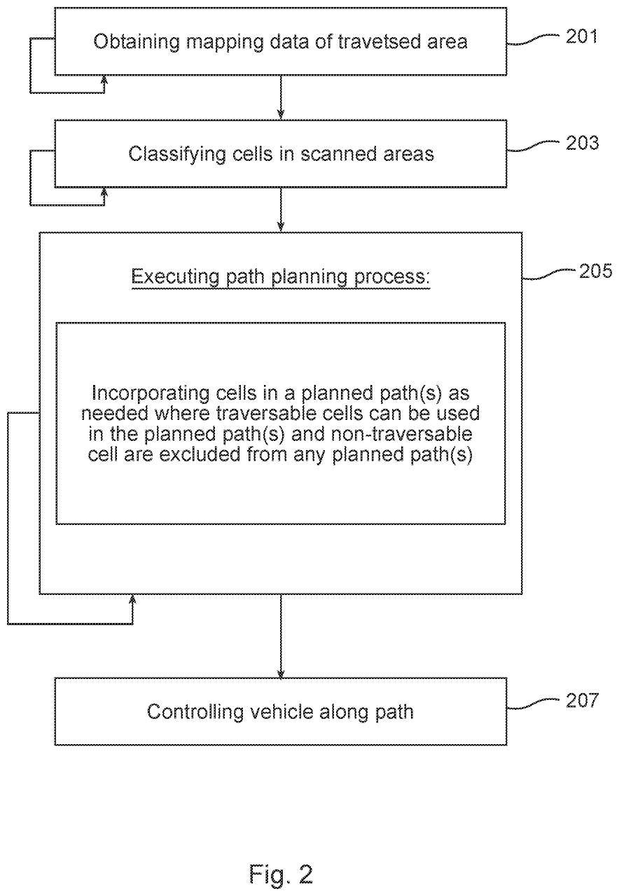

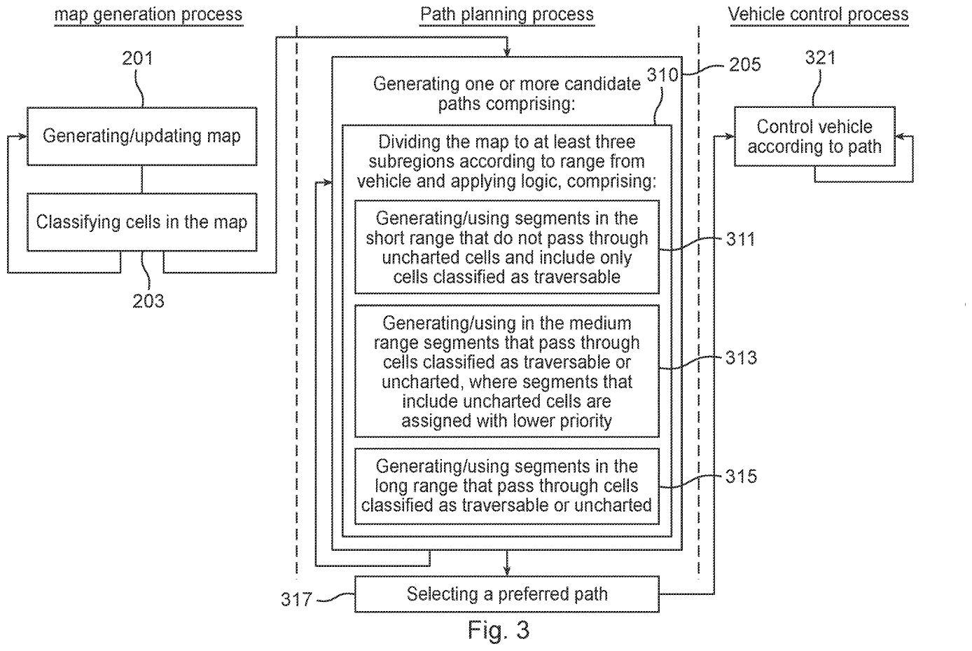

In embodiments of the presently disclosed subject matter, fewer, more and/or different stages than those shown in FIGS. 2 and 3 may be executed. In embodiments of the presently disclosed subject matter, one or more stages illustrated in the figures may be executed in a different order, and/or one or more groups of stages may be executed simultaneously.

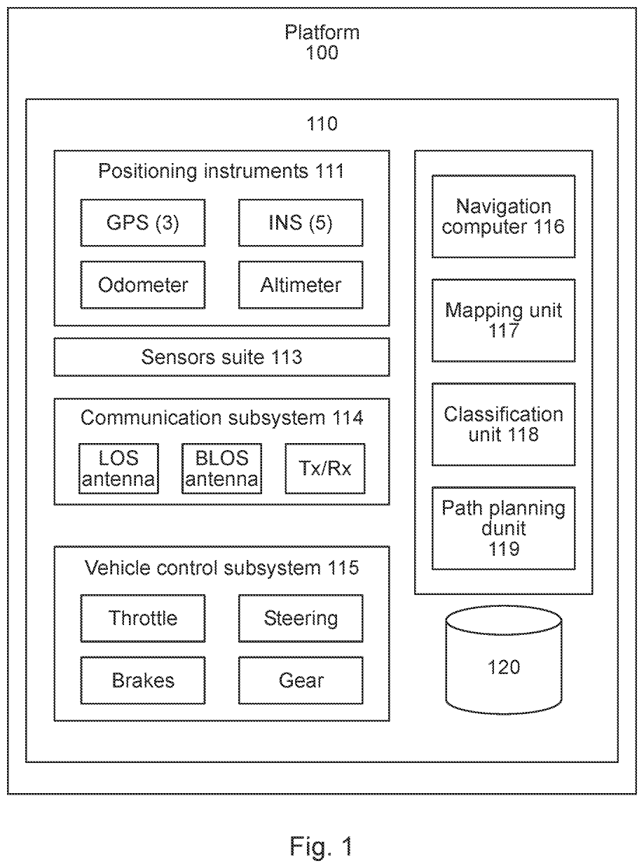

FIG. 1 illustrates a general schematic of the system architecture in accordance with a non-limiting example of the presently disclosed subject matter. Elements in FIG. 1 can be made up of any combination of software and hardware and/or firmware that performs the functions as defined and explained herein. Elements in FIG. 1 may be centralized in one location, or dispersed over more than one location. The system may comprise fewer, more, and/or different elements than those shown in FIG. 1. Likewise, the specific division of the functionality of the disclosed system to specific parts as described below, is provided by way of example, and other various alternatives are also construed within the scope of the presently disclosed subject matter. For example, FIG. 1 shows navigation computer 116, mapping unit 117, classification unit 118 and path planning unit 119 as four separate units, while it would be clear to any person skilled in the art that the functionality and/or structural design of these units can be otherwise divided or consolidated.

The term “comprising” is open-ended. As used in the specification and appended claims, this term does not exclude any additional structure or steps. Consider a claim that recites: “An apparatus comprising one or more processor units. Such a claim does not foreclose the apparatus from including additional components (e.g., a network interface unit, graphics circuitry, etc.).

For the sake of clarity, the term “substantially” is used herein to imply the possibility of variations in any prescribed value within a range of values acceptable according to practical tolerances known in the pertinent technological field. For example, the term “substantially” can be interpreted to imply possible variation between 2.5% to 15% over or under any specified value. For example, by referring to “substantially at the centre of the map” mentioned below, it is meant to include possible deviations from the exact centre within an acceptable tolerance, as would be understood by a person skilled in the art.

It is noted that while the present description predominantly refers to an unmanned ground vehicle (UGV), this should not be construed as limiting, as other types of vehicles are also contemplated within the scope of the presently disclosed subject matter. For example, an autonomous aerial vehicle (e.g., drone flying at low altitude near the ground) may likewise implement the principles disclosed herein.

The term “offroad” as used herein should be expansively construed to include any type of area which is not paved and is characterized by a surface with unknown and/or inconsistent features and/or topography. For example, an offroad area may include steep slopes, fissures, and/or holes in the ground. This includes both semi-offroad, which includes unpaved roads or ways, as well as complete offroad, which includes areas which do not include structured pathways. This is different to a paved road or way, which can be assumed to have a continuous and generally flat surface.

Bearing the above in mind, attention is drawn to FIG. 1 which is a block diagram schematically illustrating an example of an onboard system, according to examples of the presently disclosed subject matter. System 110 disclosed herein can be mounted onboard a mobile platform 100 (also referred to herein as “vehicle”). The platform can be, for example, an autonomous ground vehicle (UGV). For the sake of brevity and simplicity, some components, which may be part of the system or vehicle (e.g., engine), are not described.

According to one example of the presently disclosed subject matter, system 110 can comprise positioning instruments 111, sensors-suit 113, communication subsystem 114, vehicle control subsystem 115, navigation computer 116, mapping unit 117, classification unit 118, and path planning unit 119.

Positioning instruments 111 can comprise, for example, devices such as GPS unit, INS unit, altimeters, odometer, etc. Platform positioning instruments are configured to assist in the determination of the current position of the vehicle, defined in some examples, relative to some reference frame (e.g., Earth Centered Inertial or Earth-Centered, Earth-Fixed (ECEF), Earth Center Inertial (ECI), or a known reference point (fix)).

Positioning data obtained by the positioning instruments can be utilized by navigation computer 116 for generating navigation instructions directing the platform in a desired direction (e.g., to a desired destination). Vehicle control subsystem 115 may include various vehicle control devices such as throttle, steering, brakes, and gear. The vehicle may comprise various control units, each dedicated to controlling the operation of a respective control device. Vehicle control subsystem 115 is configured in some examples to receive vehicle navigation instructions, and, in response, to generate instructions (e.g., steering commands) for controlling the movement of the UGV 100 according to the navigation instructions.

System 110 can comprise or be otherwise operatively connected to a sensors-suit 113 comprising one or more sensors (otherwise referred to as “scanning devices”) mounted on-board the vehicle and configured to scan an area surrounding the vehicle and provide scanning output data. Scanning can be performed in one or more scanning planes, in one or more scanning rates and one or more scanning separations (i.e., angle between consecutive beams). Scanning output data includes information indicative of ranges to the terrain surfaces and objects relative to the vehicle in a multiplicity of directions around the vehicle. Examples of sensors include, but are not limited to: image sensors (including 3D cameras), LiDAR, RADAR, sonar, etc., as well as different combinations thereof.

Communication subsystem 114 is configured for enabling communication between the vehicle and other remote entities (e.g., other vehicles or a remote-control unit). Computer data storage 120 is configured to store different types of information, including, for example, maps of the areas which are being traversed (e.g., generated by mapping unit 117), information related to the planned progression path and the path planning process. In some examples, system 110 may further comprise mapping unit 117, classification unit 118, and path planning unit 119, as further explained herein below.

According to some examples, different functional elements in system 110 can be implemented as a dedicated processing circuitry comprising one or more computer processors and computer storage for executing specific operations. Additionally, or alternatively, one or more functional elements can be operatively connected to a common processing unit configured to execute operations according to instructions stored in the functional elements. For example, part or all of units 116, 117, 118 and 119 can be implemented in a single computer configured to execute operations in accordance with computer-readable instructions stored on a non-transitory computer-readable medium operatively connected to a computer processor.

In general, during operation, autonomous vehicles execute a path planning process (e.g., by path planning unit 119) that includes the planning of a path dedicated to safely and efficiently leading the vehicle within a traversed area towards a desired destination while considering various requirements and constraints. For example, a safe path is one which avoids obstacles (e.g., non-traversable or dangerous objects or areas), and an efficient path is characterized by a short distance and/or fast route leading to a desired destination. The path planning process depends on various parameters, including for example: the terrain conditions, the required vehicle destination, the traversability of the specific vehicle (i.e., its ability to traverse a certain terrain or area) and the desired vehicle operational conditions (e.g., speed of travel). Terrain conditions can be provided as mapping data (e.g., in the form of a map) that describes the area that is being traversed by the vehicle. In some examples, the path planning process is executed in real-time as the vehicle is advancing, based on sensory data and the available mapping data.

In some examples, as part of a mapping process executed from onboard the vehicle, sensors-suit 113 mounted onboard the vehicle that comprises one or more sensors, is operated for repeatedly scanning a region surrounding the vehicle. The scanning output data is processed and used (e.g., by mapping unit 117) for dynamically generating, in real-time, a map representing the scanned region based on the scanning output data. According to some examples, the map can be generated and updated around the vehicle (e.g., centred around the vehicle) and the locations of elements (e.g., surface areas and obstacles) are indicated relative to the vehicle. The map has certain dimensions (including length and width) which are generally predefined and known. Thus, in some examples the map area travels together with the vehicle, and as the vehicle is advancing and new areas are being scanned, the new areas located in the direction of travel are continuously added to the map, and older areas located at the direction opposite to the direction of travel are omitted from the area of the map.

In some examples the map is accumulative, where scanning output data obtained in consecutive scanning operations is combined and matched (overlayed) together in the same map to thereby generate an updated map with improved accuracy and detail. In other examples, in addition to, or instead of an onboard mapping process, mapping data of the traversed area can be obtained from other resources. For example, a drone flying above a ground vehicle can execute the mapping process and provide to the ground vehicle a map of the area, or an existing map can be retrieved from a data-repository.

The generated map is divided into cells where each cell represents part of the mapped area. A map can include various types of information describing the mapped area. One example of such information is altitude data describing the height of various points in the map. According to some examples, the height of the topography and land cover in the scanned area surrounding the vehicle is determined based on the readings in multiple continuous vertical scanning lines, thus providing 3-dimensional information for generating a 3-dimensional map. In other examples, e.g., to save resources, a 2.5-dimensional map may be generated and used. A 2.5-dimensional map can be generated for example by assigning a respective altitude value indicating the altitude for each cell collectively. Thus, while each cell may include multiple scanned points, each characterized by a different altitude, a single height value represents its altitude. The altitude of the cells in the map can be calculated according to various methods that provide a single height value for each cell (e.g., the cell height is defined according to highest scanned point in the cell, or according to an average value calculated from the altitudes of all sampled points in a cell). The generated map (e.g., 3-D or 2.5-D map) provides a real-time picture of the environment surrounding the vehicle (e.g., from the vantage point of the scanners located on-board the vehicle).

Cells in the map can be classified (e.g., by classification unit 118 operatively connected to mapping unit 117) to different categories, including, for example, traversable and non-traversable, where traversable cells pertain to areas which can be traversed by the vehicle, and non-traversable areas pertain to areas where obstacles are located, and which the vehicle should avoid. Obstacles include for example any object or part of the landscape that is considerably different (e.g., higher or lower and/or wider) from its surroundings, creating a physical boundary that the vehicle cannot traverse (or, in some cases, may traverse with high risk), or an area that should be avoided for some other reason. For example, a hole in the ground, a crevasse, a big boulder, a tree, etc. Another example is a slope-negative or positive-which can be non-traversable or unsafe for the vehicle. Classification of cells to traversable and non-traversable is based on several parameters including for example, the mapping data (i.e., the observed terrain conditions), the specific vehicle and its innate traversability, and the desired traveling conditions (e.g., speed of travel).

Once a map of the area is available, a path planning process can be executed, as mentioned above. Unlike autonomous vehicles that operate on roads and can generally assume the existence of a continuous and flat surface of a road extending in the direction of travel, autonomous vehicles that operate in offroad conditions face a much greater challenge, as they cannot rely on the existence of a road or surface of any kind and require a map of the traversed area for planning a path. For this reason, the accuracy of the available mapping data has a direct impact on the ability of the vehicle to plan a safe and efficient path.

However, obtaining sufficiently accurate mapping data in offroad conditions is many times a challenging task. Mapping data generated in offroad conditions often includes areas which are not scanned, or partially scanned (herein after “uncharted” or “unscanned” area), and their topographical characteristics are incomplete or unknown. Uncharted areas can result from various reasons including the inability of the sensors-suit (e.g., laser scanner) to scan such areas. Performance of the sensors-suit, and its ability to successfully scan the surrounding area, depends on various factors such as the type of sensors-suit, its scanning range and scanning rate, the number and placement of scanning devices which are installed on the vehicle, the vehicle's travelling speed, the terrain conditions, and so forth.

Uncharted areas can therefore represent either areas which are truly non-traversable and should be avoided, or areas which can be traversed. For example, when travelling in offroad conditions, negative obstacles (e.g., holes in the ground, pits, cracks, crevasses, etc.) and surface slopes can be classified into categories, including: untraversable—if they present a traversability challenge to the vehicle; traversable—if they can be easily crossed; or traversable under certain limitations (e.g., traversal at a lower speed only, or only traversal when approaching from one direction, but not from another direction). However, these types of areas are often characterized by low height relative to other parts in the map, which obstruct the scanning beams and preclude the scanning of these low areas until the vehicle is positioned at a very short distance (e.g., 1 to 5 meters). Accordingly, uncharted areas are often represented as uncharted cells in the map that do not have any specific classification.

The existence of uncharted areas presents considerable risk to the vehicle, as they may include obstacles that may seriously damage the vehicle as well as equipment and/or personnel that the vehicle may be carrying, or incapacitate the vehicle. Therefore, such areas cannot be ignored or otherwise be assumed as traversable during the path planning process. This is different to on-road conditions, in which a continuous flat surface of a road can be assumed, even in case of incomplete scanning. On the other hand, considering all uncharted cells as non-traversable would result in the generation of an inefficient path, and in some cases would even prevent the generation of a feasible path that leads to a desired destination.

The presently disclosed subject matter includes a system and method dedicated to autonomous path planning in autonomous vehicles operating in offroad environment while considering uncharted areas. More specifically, a path planning process is executed based a map of the surrounding area and includes a selective path planning logic, which is applied on uncharted cells in the map, where uncharted cells located at different ranges from the vehicle induce different limitations on the path planning process. By efficiently utilizing uncharted cells in the path planning process, this approach provides for an efficient and reliable path planning process in offroad conditions in the presence of uncharted cells, that enables the generation of a valid path while maintaining vehicle safety. Furthermore, in some examples, this approach may also help to reduce path planning time (e.g., for obtaining path planning of similar quality using other techniques).

Turning to FIG. 2, it shows a flowchart of operations carried out according to some examples of the presently disclosed subject matter. Operations described with reference to FIG. 2 describe a method dedicated to autonomous path planning in an autonomous vehicle operating in offroad environment. The path planning process is executed in real-time based on a map of the surrounding area and includes a selective path planning logic (executed for example by path planning unit 119) which is applied on uncharted cells in the map, where uncharted cells located at different ranges (different “range-zones”) from the vehicle induce different limitations on the path planning process.

While operations in FIG. 2 (as well as FIG. 3) are described herein with reference to components shown in FIG. 1, this is done for the sake of clarity of the description only and should not be construed to limit the scope of the disclosed subject to the specific design and/or components illustrated in FIG. 1.

While the vehicle is advancing in an offroad area it obtains mapping data of the area surrounding the vehicle (block 201). As explained above, such mapping data can be generated by operating a sensors-suit 113 from onboard the vehicle, configured and operable for scanning the area surrounding the vehicle, and generating a map representation of the scanned area based on the scanning output data (e.g., by mapping unit 117). The map includes scanned areas and areas which the onboard scanners were unable to scan (“uncharted areas”). The mapping data pertaining to the uncharted areas might be incomplete or completely missing.

As mentioned above, in some examples, the map is divided into cells of a certain size, where a cell in the map that pertains to a scanned area is classified to a certain class (block 203; e.g., by classification unit 118), including, for example, non-traversable cells and traversable cells. In some examples, traversable cells can be further classified to traversable cells (unconditionally) and to cells which are traversable under certain conditions (e.g., limited vehicle speed).

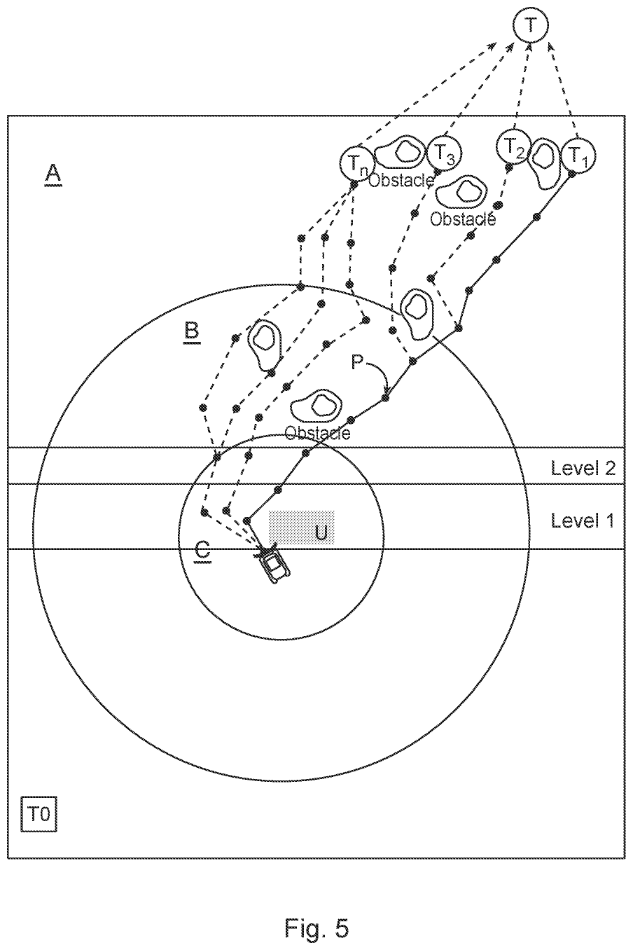

At block 205 an autonomous path planning process is executed based on the available mapping data. According to some examples, a path planning process is executed, where one or more paths leading the vehicle towards a desired destination are laid out on the map. According to one non-limiting example, the path planning process includes starting from a certain starting point (e.g., current location of the vehicle) and extending one or more segments in the general direction of the desired destination. In some examples, multiple segments, spanning from the starting point, are deployed in multiple directions at a certain angular separation (defining an angle between adjacent segment lines), where each one of the segments forms an optional path. This process continues by adding one or more segments, starting at the end of previously laid segments, thus extending the path with additional segments, each extending in a particular direction and creating a path that comprises the two segments. This is repeated until one or more stopping conditions are met, giving rise to a group of candidate paths, each optionally comprising multiple segments. This is demonstrated in FIG. 5 that shows a plurality of candidate paths leading towards the final destination T. Notably, as mentioned above, the map is generated and updated around the vehicle, and has certain dimensions, and, accordingly, the length of the map is derived from the map dimensions. In FIG. 5 the target destination T is located outside the boundaries of the map, and each candidate path has a certain end point Tᵢ within the map's boundaries, all end points leading the vehicle in the general direction of the destination T.

Once the stopping criteria is met, a path selection procedure occurs, where a preferred (or “selected”) path is selected from the group of candidate paths, and the vehicle proceeds along the selected path. Examples of stopping conditions include termination of a certain time-period assigned for path planning, receiving a new map-update (generated based on updated scanning output), where new paths are generated for each map-update, and the generation of a predefined number of candidate paths.

In some examples, each candidate path is assigned with a score according to various parameters, and a preferred path is selected based on the scores assigned to different candidate paths (e.g., the path assigned with the lowest score). Assigning a score to a path can take into account various parameters, such as proximity of the end point of the path to the destination, number of segments in the path, turning angles between segments, proximity of the path to obstacles, whether the path passes through allowed but undesired areas, deviation from recognized roads (which may be an advantage or a disadvantage), whether the path passes through predefined waypoints, or the like. In FIG. 5 the selected (preferred) path is denoted by a solid line, and the other candidate paths are denoted by a broken line.

According to some path planning techniques, the candidate paths are generated, where segments are laid on the classified map that comprises classified cells, and afterwards segments which traverse a non-traversable cell are removed. Optionally, the excluded segments are replaced by one or more alternative segments which do not traverse the non-traversable cell. An example of a path planning technique which implements this principle is described in US Patent Application number US20200208993, which is incorporated herein by reference in its entirety.

In some examples, as part of the path planning process, candidate paths are validated by simulating movement of a vehicle signature, defined for example as a three-dimensional volume encapsulating the vehicle (which may be somewhat larger than the actual volume of the vehicle), along the candidate path, and if the candidate path leads the signature into a non-traversable cell, the candidate path is defined as invalid. Invalid paths can be discarded or updated, where invalid segments (which traverse non-traversable cells) are replaced by valid segments.

In some examples, during the path planning process the map is divided into levels, where, in each level candidate segments are spanned out (e.g., as a spanning tree) over a limited area of the map. This is demonstrated in FIG. 5 showing level 1 and level 2. For each level, segments are validated (e.g., by simulating of movement of vehicle signature over each candidate segment) and those which traverse a non-traversable cell and are identified as invalid, are excluded. If one or more valid segments are available in a given level, the process continues to the next level, where additional segments are spanned out of the end of the segments in the previous level, thus creating a multiplicity of candidate paths and excluding invalid segments as the candidate paths are being generated. Notably, in some examples, classification of cells into traversable and non-traversable is also performed as part of the path planning process (e.g., where operations described with reference to block 203 are consolidated with the path planning process), where simulation of movement of the vehicle signature over each segment serves for classifying cells as traversable and non-traversable as well.

According to other path planning techniques before the path planning process, the cells in the map are classified, and those cells which are classified as non-traversable are excluded from the path planning process, such that segments are restricted from being laid on non-traversable cells in the first place.

Regardless of the specific path planning technique that is being implemented, classification of the cells in the map is needed to complete the path planning process. However, as explained above, maps often contain uncharted cells that do not have specific classification.

The path planning process disclosed herein applies special logic devised for dealing with uncharted cells which are not classified to any one of these categories, thereby improving the efficiency of the path planning process.

FIG. 3 shows a specific example where the map is divided into three subregions (block 310). Notably, in other examples, more than three subregions can be used in the path planning process. As demonstrated in FIG. 3, in some examples the map generation, the path planning, and vehicle control are three distinct processes which are executed asynchronously. As the vehicle advances new map updates are repeatedly generated by using new scanning output data (e.g., by mapping unit 117), the new map updates are used for planning and updating the path (e.g., by path planning unit 118), and the path is used by the vehicle controls to lead the vehicle. In general, when executing path planning, the most updated available map is used, and when generating control commands, the most updated available path is used.

As explained above, maps of the area surrounding the vehicle are generated and updated as the vehicle is advancing, based on scanning output data, and may contain both scanned and unscanned areas. Maps are divided into cells, where cells in the scanned areas are classified according to their traversability, and cells in the unscanned area are defined as “uncharted” (blocks 201-203).

At block 205 a path generation process is executed, where one or more candidate paths are generated, and a preferred path is selected. In general, cells located in scanned areas can be classified and used in the path planning process according to the classification output, where cells which are classified as untraversable are excluded from the path. Notably, exclusion of cells from the path can be done according to the specific path planning technique which is being used. For example, according to the first path planning technique mentioned above, exclusion of non-traversable cells is done by removing segments that include such cells. This can be done, either once the candidate path is complete, or while the candidate path is being constructed (e.g., for each level individually), as explained above. According to the second path planning technique which prescribes the identification of non-traversable cells in the map and deploying segments that do not pass over non-traversable cells, exclusion of non-traversable cells is done by identifying non-traversable cells and generating segments that do not traverse such cells in the first place.

According to the presently disclosed subject matter, uncharted cells which pertain to unscanned areas are identified and are processed according to their respective range from the vehicle. The map is divided into a plurality of subregions, including for example: close-range, medium-range, and long-range (block 310). Notably, close, medium, and long are relative terms defined one with respect to the other. The actual value of these ranges may differ from case to case depending on various parameters, such the size of the map and the vehicle speed. Assuming, for example, a map of about 70 meters long and a slow driving speed (e.g., 20 KPH or slower), close range may be up to 5 meters from the vehicle, medium range may be between 5 to 20 meters from the vehicle, and long range is anything beyond 25 meters. Furthermore, as mentioned below, the size of the different subregions can be dynamically updated in real-time according to various parameters such as vehicle speed.

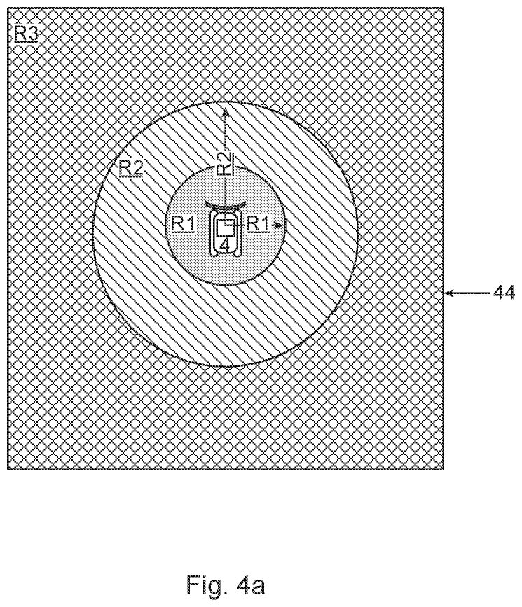

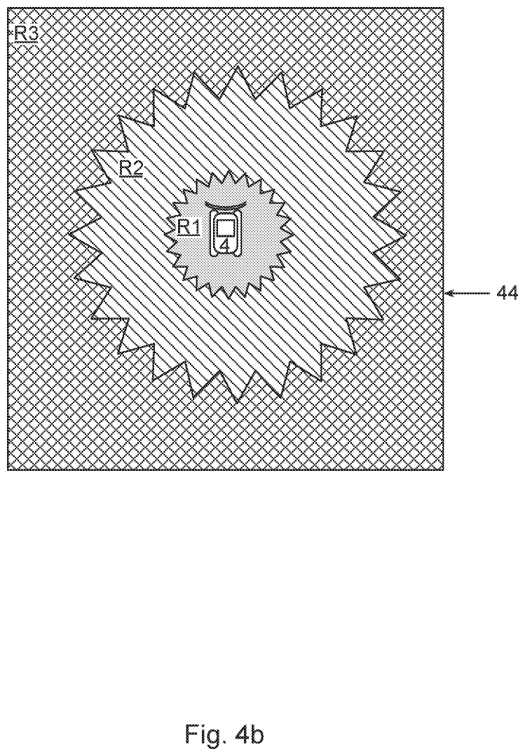

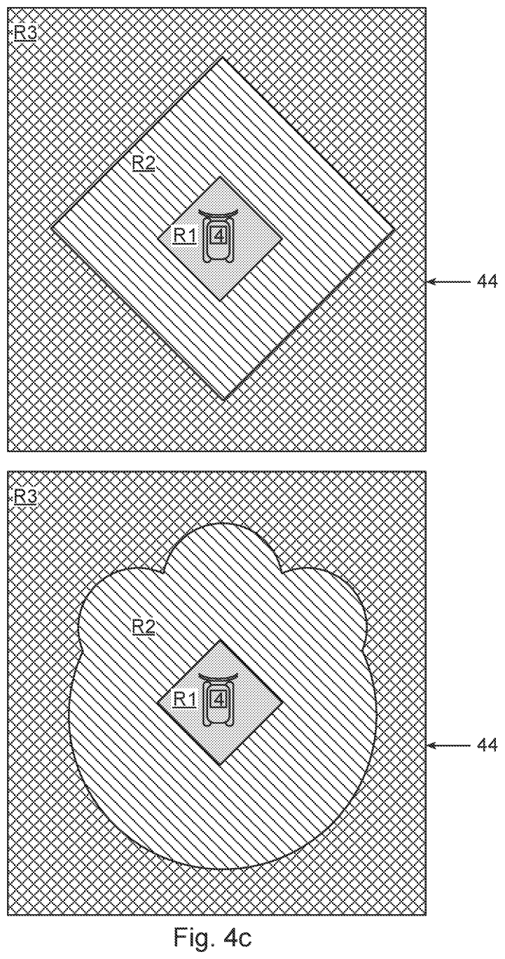

In some examples, each subregion is defined as a radius circumventing the vehicle. Referring to FIGS. 4a-4c which schematically illustrate the division of the map into three subregions. FIG. 4a shows autonomous vehicle 4 positioned substantially at the centre of the map 44 surrounding the vehicle. As shown, three subregions are defined, R1-close-range subregion, R2-medium-range subregion, extending between R1 and R2, and a long-range subregion, R3, extending between R2 and the map perimeters. The subregions can be defined in other ways, different than what is shown in FIG. 4a. For example, each subregion can be defined by an arc extending from the left edge of the map to the right edge of the map located at a certain distance from the vehicle. Notably, a subregion is not necessarily defined by a single range from the vehicle and can be otherwise defined by a line having different shapes characterized by multiple ranges from the vehicle. This is demonstrated in FIG. 4b, which shows subregions (range-zones) characterized by a star-shape and FIG. 4c, which shows subregions characterized by a rhombus shape (top). Notably, the shape is not necessarily symmetrical in all directions as demonstrated at the bottom of FIG. 4c.

According to some examples during the path planning process, uncharted cells located in the short-range subregion (R1) are considered as non-traversable, and, accordingly, such cells are excluded from the candidate paths. Accordingly, during generation of the candidate paths, segments in the short-range subregion are incorporated for generating the candidate paths only if they do not include uncharted cells (block 311). One underlining premise of this principle is that at these ranges there is little or no time for updating the path, and therefore segments in the close range in the selected path are the actual segments that will be followed by the vehicle, and, accordingly, the risk of entering a non-traversable area is reduced to a minimum by excluding uncharted cells. Also, it can be assumed that the areas near the vehicle which were initially at the long range, then at the medium range, and are now at the short range, should have already been well scanned by now, so additional data is less likely to be obtained with respect to these areas.

In general, uncharted cells located within the medium range subregion are assigned with lower priority, such that the use of these cells in the path planning process is allowed, but if other segments that do not contain uncharted cells are available, they are more preferable and can be used instead. Accordingly, during generation of the candidate paths, segments in the medium-range subregion that are incorporated for generating the candidate paths may include uncharted cells (block 313). In some examples the score of such segments is penalized to negatively affect the score of the candidate path in which they are incorporated and provide an advantage to other segments in the medium-range subregion, which do not comprise uncharted cells (and to other candidate paths that do not comprise segments with uncharted cells). In some examples, the value of the penalty that is assigned to a segment in the medium-range subregion depends on the number of uncharted cells that are incorporated in the segment, where the greater the number of uncharted cells, the greater is the penalty. One underlining premise of this principle is that there is some time before the vehicle reaches this area of the path, and, accordingly, updated scanning data pertaining to the uncharted cell may be obtained during this time. However, since these areas are closer to the current position of the vehicle than those at the long-range subregion, it is preferable that they are not used when planning the path, as they may represent non-traversable areas.

In the long-range subregion, uncharted cells are used in the path planning process as if they are traversable cells, without any restrictions other than normal path planning restrictions. Accordingly, during generation of the candidate paths, segments in the long-range subregion that are incorporated for generating the candidate paths may include uncharted cells (block 313). The underlining premise of this rule is that, as the vehicle advances towards these cells, areas that can be scanned by the sensors-suit will be scanned. Because of the long range, it is assumed that there is sufficient time to scan the unscanned areas and update the path according to the classification of these scanned areas. Notably, as mentioned above, in some examples the map is generated as an accumulative map, and it is therefore likely that unscanned areas will be scanned in future scans and become scanned areas in future map updates, and therefore uncharted cells in these areas will be classified as traversable or non-traversable.

In some examples, if all feasible paths leading to the desired destination necessitate traversal over uncharted cells located in the medium-range subregion, an autonomous vehicle control command is generated, instructing to reduce vehicle speed, to thereby increase probability of successfully scanning unscanned areas in subsequent scans and obtain valid segments (that do not include uncharted cells) for traversing the close-range subregion. Speed control commands are executed by providing instructions to one or more vehicle control subsystems, e.g., throttle and/or braking subsystem.

Candidate paths are generated while the path generation process that is executed with respect to a certain map update continues until some stopping condition is met (e.g., designated time terminates), and a preferred path is selected (317) and the vehicle advances along the selected path towards the destination (block 321). For example, vehicle control subsystem 115 may execute instructions dedicated to controlling the vehicle (100) along the preferred path according to the instructions.

The path planning process disclosed herein above is a dynamic process, where scanning output data is continuously obtained (e.g., by the sensors-suit 113) and used for updating and improving the map. As the map is being updated and previously uncharted areas are scanned, cells in these areas can be classified. Previous uncharted cells in newly scanned areas, which are classified as traversable, can be incorporated and used in the planned path. Previously uncharted cells in newly scanned areas which are classified as non-traversable should be excluded from the planned path. More specifically, segments that comprise uncharted cells which were previously incorporated in the planned path (e.g., in the long-range and medium-range regions) and are classified as traversable, can be retained in the planned path, and segments that comprise uncharted cells which were previously incorporated in the planned path and are classified as non-traversable, are removed from the planned path.

As the vehicle is advancing along the preferred path, new areas are scanned and added to the map, and new segments are laid out on these areas and used for generating/updating the paths. Thus, after a preferred path has been selected, and while the vehicle is advancing along the selected path, the process described above continues, where multiple paths are generated and/or updated. These paths include the preferred path which is being updated, and may also include previously generated and unselected candidate paths which are being updated, and/or newly generated candidate paths which are being added to the pool of candidate paths.

As the vehicle is advancing, new areas are included in the long-range subregion, areas in the map that were previously in the long-range subregion move to the medium-range subregion, areas in the map that were previously in the medium-range subregion move to the short-range subregion, and areas that were previously in the short-range subregion, move out of the map area. Thus, the location of cells in the map, relative to the different subregions, changes with advancement of the vehicle. Thus, the path planning process is a repetitive process where candidate paths are repeatedly generated, serving as alternatives that can be immediately switched to and used in case the selected path is found to be suboptimal according to the real-time conditions and scanning output data.

For example, assume the selected path includes uncharted cells previously identified in the long-range subregion, that are now located in the medium-range sub-region. The segments in the selected path that comprise these uncharted cells are revaluated considering the penalty to the respective score which is applied to uncharted cells in the medium-range subregion. Consequently, the overall score assigned to the selected path may change. If, due to the penalty, the score of the selected path is reduced, and there is a different candidate path with a higher score, the other path is selected and used instead.

In another example, assume the selected path includes uncharted cells previously identified in the medium-range subregion that are now located in short-range sub-region. The segments in the selected path that comprise these uncharted cells are considered as invalid, as these cells are classified as non-traversable. Consequently, in some examples the selected path may be updated to include alternative segments instead, and are revaluated against other available candidate paths to select the preferred path given the updated scores of the candidate paths. If, however, the uncharted cells, which are now located in the short-range subregion, are scanned and classified as traversable, the selected path can continue to be used by the vehicle.

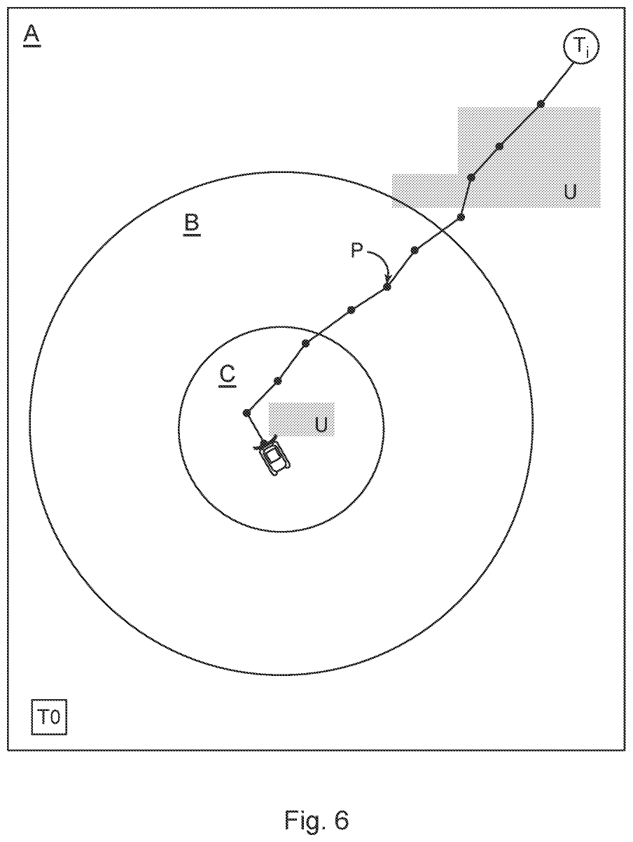

Referring to FIG. 6, it illustrates an example of a possible path planning scenario. Notably, examples described with reference to FIGS. 6, 7 and 9 show only the preferred path, and not any other candidate paths or segments. FIG. 6 shows a map of a traversed area (at time T₀) generated relative to the vehicle, where the vehicle is positioned substantially at the centre of the map and is advancing towards destination T. Uncharted cells in the map are indicated as grey rectangles and are marked by the letter ‘U’. Notably, there is one group of uncharted cells which is in the short-range subregion (C), and another group of uncharted cells which is in the long-range subregion (A). Uncharted cells in the short-range subregion are treated as non-traversable, and, accordingly, a path (P) is planned so it circumvents these cells.

Uncharted cells in the long-range subregion are treated as traversable, and accordingly the path is planned to traverse these cells.

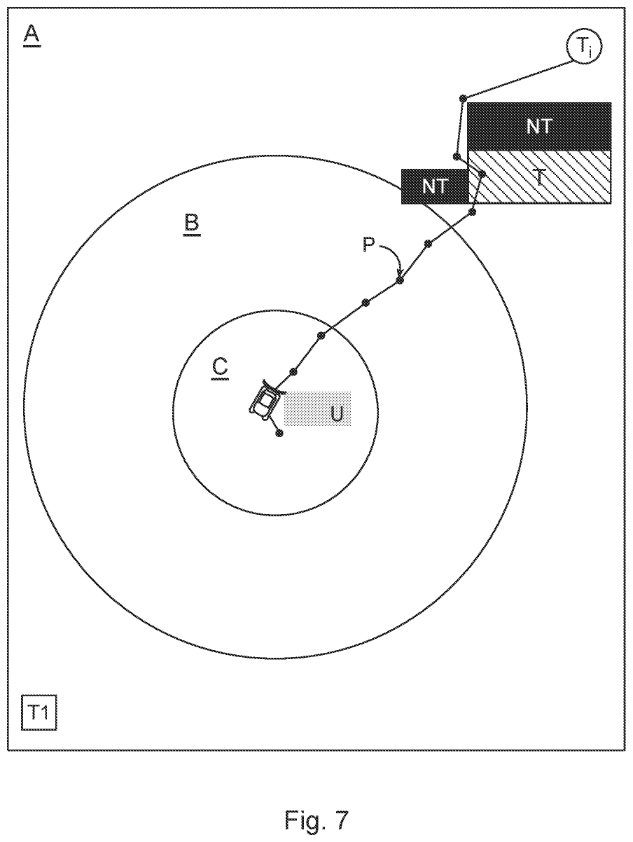

FIG. 7 schematically illustrates a possible continuation of the scenario in FIG. 6. As the vehicle advances along the path, an updated map is provided (at T₁) generated based on updated scanning output data that provides more accurate information with respect to the group of uncharted cells in the long-range subregion. In the updated map the area previously indicated (in a previous map) as uncharted, has been scanned. The newly scanned area is classified, where a part of the area is classified as traversable (T), and another part is classified as non-traversable (NT). As shown in the illustration, the path (P) is updated to include one or more new segments which circumvent the area of the non-traversable cells.

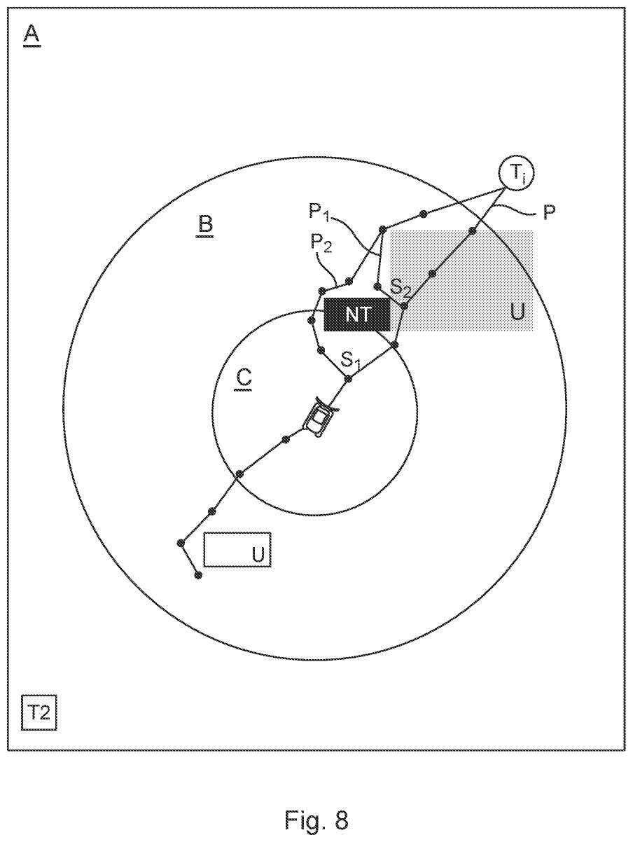

FIG. 8 schematically illustrates an alternative continuation of the scenario in FIG. 6. In FIG. 8 the vehicle has advanced along the path, such that the uncharted area previously located in the long-range subregion is now located in the medium-range region. Uncharted cells in the medium-range subregion induce a penalty on the score which is assigned to the respective segments. As shown in the illustration, the selected path (P) is updated to include new segments which circumvent most of the uncharted cells (the previous path is marked by broken lines), providing an alternative candidate path (P₁) branching from path (P) to the right at branching point S₁ and to the left at branching point S₂. The alternative path P₁ retains a few segments that traverse uncharted cells. Another candidate path (P₂) is generated circumventing the area of non-traversable cells, branching from path (P) to the left at branching point S₁. Path P₂ excludes all non-traversable cells. According to this example, path P₁ is selected as the preferred path. This is so because of the non-traversable area (NT) located adjacent to the uncharted area inducing a longer distance of travel for path P₂ as it circumvents the non-traversable cells. Due to this longer distance, the score assigned to path P₁ is better than that which is assigned to path P₂, notwithstanding the uncharted cells in path P₁, and accordingly path P₁ is preferred over P and P₂.

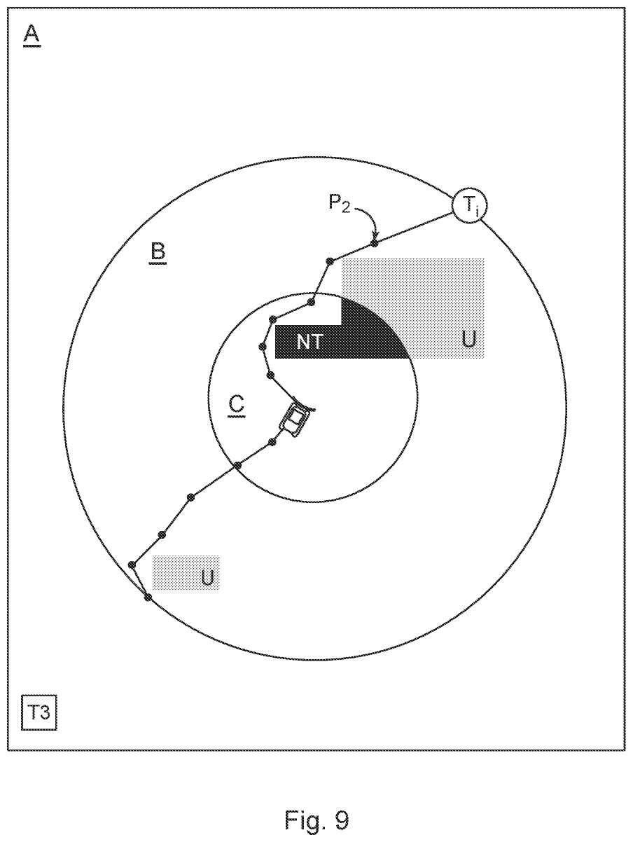

Notably, as mentioned above, the path planning process disclosed herein may include the simultaneous generation of multiple alternative paths, each following different routes to the desired destination. As the vehicle advances, any one of the alternative paths (possibly all) may be updated any number of times as scanning output data of uncharted areas becomes available. As the planned paths are being updated some paths may become unfeasible and are removed from the pool of paths. FIG. 9 schematically illustrates a possible continuation of the scenario in FIG. 8. In FIG. 9 the vehicle has advanced along the path, such that part of the uncharted area previously located in the medium-range subregion is now located in the short-range region. In this case the updated map did not include new scanning output data which transforms the unscanned area to a scanned area. As uncharted cells in the short-range subregion are considered non-traversable, path P₁ (not shown in FIG. 9) which includes segments that traverse the uncharted cells (now considered non-traversable) becomes invalid, and accordingly the vehicle selects path P₂ as the selected path instead. Notably, additional alternative paths can be generated and used instead of path P₂.

According to some examples, system 100 is configured to dynamically change the size of the different subregions according to predefined logic (e.g., path planning unit 119 can be configured to implement such logic and update the size of the subregions accordingly). The logic can include conditions which induce change to the size of the subregions.

For example, the logic can include speed criteria. In one example the size of the short-range subregion and/or long-range subregion can change according (e.g., in proportion) to the vehicle speed. For instance, increase of the vehicle speed may induce an increase in the short-range subregion and/or decrease in the long-range subregion, and a decrease in the vehicle speed induces a decrease in the short-range subregion and/or increase in the long-range subregion. The size of the medium-range subregion can be adapted in a similar manner.

Other operational conditions that may affect the size of the subregions include the overall topography in which the vehicle is traveling, where, if the vehicle is traveling in an area characterized by complex and dangerous topography, or in an area which is characterized by high obstacle density, the size of the short-range region is increased and the size of the long-range subregion (and or medium-range subregion) is decreased, and if the vehicle is traveling in an area characterized by a generally flat and simple topography, or with low obstacle density, the short-range region is decreased and the size of the long-range subregion (and or medium-range subregion) is increased. Information describing the general characteristics of the topography of the traversed area can be obtained, for example, at the onset of the mission before entering the area, or can be received in real-time from another resource e.g., by a communication subsystem. Furthermore, the mapping data output (e.g., generated by mapping unit 117) can be analysed to determine obstacle density, and/or topography and the size of the subregions can be dynamically adapted according to the determined obstacle density and/or topography. For example, system 110 can be configured to process the map and determine how many obstacles (or non-traversable cells) are identified in the map, and determine obstacle density as the number of obstacles and/or the area they cover out of the total area of the map.

By dynamically adapting the size of the different subregions it is made possible to mitigate risks to the vehicle that may be caused by operational conditions such as vehicle speed, obstacle density and/or topography, and preserve a desired level of vehicle safety. On the other hand, by dynamically adapting the size of the different subregions it is made possible to control (toggle) the risk level to the vehicle according to preferences that can be determined in real-time. For example, assuming the vehicle is executing a high priority mission that requires fast vehicle movement, even at the risk of harming the vehicle (e.g., vehicle located in area with an imminent risk of a flash flood that should quickly exit the area), the size of the different subregions can be adapted to enable faster movement. By reducing the size of the short-range sub-region and increasing the size of the long-range subregion, more permissive path planning is enabled by allowing traversal over unscanned areas in the long-range subregion, which, in turn, can be translated into shorter paths. In some examples, the size of the short-range subregion and long-range subregion can be adapted by changing the penalty to the score of candidate paths that crosses uncharted cells located in the medium-range subregion. For instance, by setting the penalty of uncharted cells in the medium-range subregion to zero, no penalty is applied for traversal of uncharted cells in the medium range, thus, essentially, merging the medium-range subregion with the long-range sub-region. At the other extreme, by setting the penalty to a very large value, the applied penalty would render any candidate path that traverses uncharted cells as invalid, thus essentially merging the medium-range subregion with the short-range sub-region. Thus, system 110 can be configured to adapt the value of the penalty assigned for crossing uncharted cells in the medium-range subregion in order to control the agility of path planning, and, as a consequence, the agility and permissiveness of movement of the vehicle within the traversed area versus vehicle safety.

1-30. (canceled)

31. A computer implemented method of autonomous path planning in an autonomous vehicle for traversing an area in offroad conditions, the method comprising:
obtaining a map representing an area around the vehicle; wherein the map is generated by scanning an area around the vehicle and comprises at least one scanned area and at least one unscanned area;
generating one or more candidate paths leading the vehicle towards a desired destination, wherein the generating comprises:
dividing the map into a plurality of subregions, each subregion being defined by one or more respective ranges from the vehicle, including at least: short-range subregion, medium-range subregion, and long-range subregion; wherein the map is divided into cells, where cells in a scanned area are classified to a class selected from at least two classes, comprising traversable and non-traversable, and wherein cells in an unscanned area are defined as uncharted cells;
applying a selective path planning logic on uncharted cells depending on the respective subregion in which they are located, wherein:
in the short-range subregion, considering uncharted cells as non-traversable;
in the long-range subregion, considering uncharted cells as traversable;
excluding from the one or more candidate paths, segments that include cells classified as non-traversable and segments that include uncharted cells located in the short-range subregion;
selecting a preferred path from the one or more candidate paths; and
generating steering instructions for steering the vehicle in accordance with the path.

32. The method of claim 31, wherein applying the selective path planning logic further comprises:
in the medium-range subregion, applying a penalty to a segment that includes uncharted cells that negatively affects a score of a respective candidate path that includes the segment.

33. The method of claim 32, further comprising:
dynamically updating one or more candidate paths as the vehicle is advancing along the preferred path, comprising:
obtaining an updated map generated based on updated scanning output data, wherein the update map comprises one or more of: an unscanned area that was previously in the medium-range subregion of the map and is in the short-range subregion; and an unscanned area that was previously in the long-range subregion and is in the medium-range subregion;
excluding segments, from any one of the one or more candidate paths, that cross uncharted cells in the short-range subregion;
and applying a penalty to segments, in any one of the one or more candidate paths, that cross uncharted cells in the medium-range subregion, where the penalty negatively affects a respective score of a candidate path;
recalculating a respective score for each candidate path; and selecting a preferred path from the one or more candidate paths according to the respective scores;
and generating steering instructions for steering the vehicle in accordance with the path.

34. The method of claim 32, responsive to determining that the preferred path includes segments crossing the short-range subregion that include uncharted cells, updating the preferred path to replace the segments with one or more other segments that circumvent the uncharted cells.

35. The method of claim 31 further comprising:
responsive to identifying uncharted cells in the medium-range subregion, generating a speed control command for slowing down the vehicle to thereby increase probability of successfully scanning unscanned areas in subsequent scans.

36. The method of claim 31, further comprising:
operating a sensors-suit comprising one or more sensors onboard the vehicle for repeatedly scanning the area around the vehicle, to thereby generate respective scanning output data; and
operating a computer for generating and updating the map based on the scanning output data.

37. The method of claim 31, further comprising: dynamically adapting the size of one or more of the plurality of subregions according to one or more real-time operational conditions, wherein the one or more real-time operational conditions include vehicle speed, the method further comprising:
responsive to increase in vehicle speed, increasing the size of the short-range subregion and decreasing the size of the long-range subregion and/or medium-range subregion.

38. The method of claim 31 further comprising: executing the steering instruction and controlling one or more control devices for leading the vehicle along the preferred path.

39. The method of claim 31 wherein the vehicle is an Unmanned Ground Vehicle.

40. The method of claim 31, wherein the map is generated relative to the vehicle by accumulating scanning output data in an advancement direction of the vehicle as the vehicle advances, and omitting from the map scanning output data representing areas in a direction opposite to the advancement direction.

41. A computer system mountable on an autonomous vehicle for autonomous path planning for traversing an area in offroad conditions, the system comprising at least one processing circuitry configured to:
obtain a map representing an area around the vehicle, wherein the map is generated by scanning an area around the vehicle and comprises at least one scanned area and at least one unscanned area;
generating one or more candidate paths leading the vehicle (from a current location) towards a desired destination, wherein the generating comprises:
divide the map into a plurality of subregions, each subregion being defined by one or more respective ranges from the vehicle, including at least: short-range subregion, medium-range subregion, and long-range subregion; wherein the map is divided into cells, where cells in a scanned area are classified to a class selected from at least two classes, comprising traversable and non-traversable, and wherein cells in an unscanned area are defined as uncharted cells;
apply a selective path planning logic on uncharted cells, depending on the respective subregion in which they are located, wherein:
in the short-range subregion, considering uncharted cells as non-traversable;
in the long-range subregion, considering uncharted cells as traversable;
exclude from the one or more candidate paths segments that include cells classified as non-traversable and segments that include uncharted cells located in the short-range subregion;
select a preferred path from the one or more candidate paths; and generating steering instructions for steering the vehicle in accordance with the path.

42. The system of claim 41 wherein the at least one processing circuitry is configured for applying the selective path planning logic to:
in the medium-range subregion, assign a penalty to a segment that includes uncharted cells that negatively affect a score of a respective candidate path that includes the segment.

43. The system of claim 42, where the at least one processing circuitry is configured to:
dynamically update one or more candidate paths as the vehicle is advancing along the preferred path, the updating comprising:
obtaining an updated map generated based on updated scanning output data, wherein the update map comprises one or more of: an unscanned area that was previously in the medium-range subregion of the map and is in the short-range subregion; and an unscanned area that was previously in the long-range subregion and is in the medium-range subregion;
excluding segments, from any one of the one or more candidate paths, that cross uncharted cells in the short-range subregion;
and applying a penalty to segments, in any one of the one or more candidate paths, that cross uncharted cells in the medium-range subregion, where the penalty negatively affects a respective score of a candidate path;
recalculating a respective score for each candidate path; and selecting a preferred path from the one or more candidate paths according to the respective scores; and generating steering instructions for steering the vehicle in accordance with the path.

44. The system of claim 42, wherein the at least one processing circuitry is configured, responsive to determining that the preferred path includes segments crossing the short-range subregion, that include uncharted cells, to update the preferred path to replace the segments with one or more other segments that circumvent the uncharted cells.

45. The system of claim 42, wherein the at least one processing circuitry is further configured, responsive to identifying uncharted cells in the medium-range subregion, to generate a speed control command for slowing down the vehicle to thereby increase probability of successfully scanning unscanned areas in subsequent scans.

46. The system of claim 41 further comprises or is otherwise operatively connected to a sensors-suit comprising one or more sensors onboard the vehicle for repeatedly scanning the area around the vehicle, to thereby enable generation of respective scanning output data; and wherein the one or more processing circuitries is further configured to generate and update the map based on the scanning output data.

47. The system of claim 42, wherein the at least one processing circuitry is further configured to dynamically adapt size of two or more of the plurality of subregions according to one or more real-time operational conditions; wherein the one or more real-time operational conditions include vehicle speed, wherein the at least one processing circuitry is configured, responsive to increase in vehicle speed, to increase the size of the short-range subregion and decrease the size of the long-range subregion and/or medium-range subregion.

48. The system of claim 42, wherein the at least one processing circuitry is further configured to dynamically adapt size of two or more of the plurality of subregions according to one or more real-time operational conditions; wherein the one or more real-time operational conditions include vehicle speed, wherein the at least one processing circuitry is configured, responsive to decrease in vehicle speed, to decrease the size of the short-range subregion and increase the size of the long-range subregion and/or medium-range subregion.

49. The system of claim 42, wherein the at least one processing circuitry is further configured to dynamically adapt size of two or more of the plurality of subregions according to one or more real-time operational conditions that include obstacle density, wherein the at least one processing circuitry is configured to determine obstacle density, and responsive to determination that obstacle density is above a certain value, increase the size of the short-range subregion and decrease the size of the long range-subregion and/or medium-range subregion.

50. The system of claim 41 further comprising or is otherwise operatively connected to a vehicle control subsystem configured for manoeuvring the vehicle, wherein the vehicle control subsystem is configured to execute a steering instruction to thereby manoeuvre the vehicle along the preferred path.

51. The system of claim 41, wherein the vehicle is an Unmanned Ground Vehicle.

52. An Unmanned Vehicle comprising a system for autonomous path planning for traversing an area in offroad conditions, the system comprising at least one processing circuitry configured to:
obtain a map representing an area around the vehicle, wherein the map is generated by scanning an area around the vehicle and comprises at least one scanned area and at least one unscanned area;
generating one or more candidate paths leading the vehicle (from a current location) towards a desired destination, wherein the generating comprises:
divide the map into a plurality of subregions, each subregion being defined by one or more respective ranges from the vehicle, including at least: short-range subregion, medium-range subregion, and long-range subregion; wherein the map is divided into cells, where cells in a scanned area are classified to a class selected from at least two classes, comprising traversable and non-traversable, and wherein cells in an unscanned area are defined as uncharted cells;
apply a selective path planning logic on uncharted cells, depending on the respective subregion in which they are located, wherein:
in the short-range subregion, considering uncharted cells as non-traversable;
in the long-range subregion, considering uncharted cells as traversable;
exclude from the one or more candidate paths segments that include cells classified as non-traversable and segments that include uncharted cells located in the short-range subregion;
select a preferred path from the one or more candidate paths; and generating steering instructions for steering the vehicle in accordance with the path.

53. A computer-readable storage medium comprising instructions, which, when executed by a computer, cause the computer to perform a method of autonomous path planning in an autonomous vehicle for traversing an area in offroad conditions, the method comprising:
obtaining a map representing an area around the vehicle; wherein the map is generated by scanning an area around the vehicle and comprises at least one scanned area and at least one unscanned area;
generating one or more candidate paths leading the vehicle towards a desired destination, wherein the generating comprises:
dividing the map into a plurality of subregions, each subregion being defined by one or more respective ranges from the vehicle, including at least: short-range subregion, medium-range subregion, and long-range subregion; wherein the map is divided into cells, where cells in a scanned area are classified to a class selected from at least two classes, comprising traversable and non-traversable, and wherein cells in an unscanned area are defined as uncharted cells;
applying a selective path planning logic on uncharted cells depending on the respective subregion in which they are located, wherein:
in the short-range subregion, considering uncharted cells as non-traversable;
in the long-range subregion, considering uncharted cells as traversable;
excluding from the one or more candidate paths, segments that include cells classified as non-traversable and segments that include uncharted cells located in the short-range subregion;
selecting a preferred path from the one or more candidate paths; and generating steering instructions for steering the vehicle in accordance with the path.
